(19) United States
(12) Patent Application Publication
(10) Pub. No.: US 2004/0208540 A1
(43) Pub. Date: Oct. 21, 2004

(54) Node and wavelength division multiplexing ring network

(76) Inventors: Ichiro Nakajima, Kawasaki (JP); Satoshi Kuroyanagi, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/125,807

(22) Filed: Apr. 19, 2002

(30) Foreign Application Priority Data
Dec. 10, 2001 (JP) 2001-376355

(51) Int. Cl. H04B 10/20; H04J 14/00; H04J 14/02

(52) U.S. Cl. 398/45

(57) ABSTRACT

In nodes comprising a wavelength conversion function and a wavelength division multiplexing ring network constituted by these nodes, a signal inserter converts a wavelength of a signal branched from nodes connected to another ring network into a collision-free signal, and inserts the converted signal into a signal in the network of the node itself.

### BACKGROUND OF THE INVENTION

1. Field of the Invention

The present invention relates to a node and a wavelength division multiplexing ring network, in particular to a node connecting a plurality of ring networks and a wavelength division multiplexing ring network comprising the node and the ring networks.

2. Description of the Related Art

FIG. 16 shows a prior art example of an Optical Add/Drop Multiplexer (OADM) as a node capable of inserting/branching (adding/dropping) a signal into/from a Wavelength Division Multiplexing (hereinafter, occasionally abbreviated as WDM) ring network from a predetermined port with a predetermined wavelength.

The optical add/drop multiplexer is composed of a demultiplexer 1 for demultiplexing a wavelength division multiplexing optical signal incoming from an input transmission channel (ring-type optical fiber) RF, 2×2 type optical switches 8_1 to 8_{—}n (hereinafter, occasionally represented by a reference numeral “8”; the same being applied to other reference numerals.) for selecting a signal passed through a node and a signal to be inserted/dropped, and a multiplexer 3 for multiplexing optical signals again.

In this optical add/drop multiplexer, only a signal with a wavelength λ1 can be inserted (added) from an inserting port of the optical switch 8_1, and only a signal with a wavelength λn can be inserted from an inserting port of the optical switch 8_{—}n.

In addition, only the signal with the wavelength λ1 can be dropped at an output port of the optical switch 8_1, and only the signal with the wavelength λn can be dropped at an output port of the optical switch 8_{—}n.

Even if the signal with the wavelength λn is inserted into the input port for the wavelength λ1, it cannot be passed through the multiplexer 3.

FIG. 17 shows a prior art example (1) where ring networks are connected with such an optical add/drop multiplexer. In this example, each of the nodes N1 to N18 has a configuration of FIG. 16. Furthermore, a branching port of the optical switch 8 of an optical add/drop multiplexer OADM2 corresponding to a node N4, and the inserting port of the optical switch 8 of an optical add/drop multiplexer OADM3 corresponding to a node N6 are simply connected. For the sake of simplifying the description, a node controller, an operating system, and the like are omitted here.

A case where a path is set between routers R1 and R2 will now be described.

A signal from the router R1 is converted into a signal with a wavelength λ1 by fixed-wavelength transponders 9_1 to 9_128. Then, the converted signal is transmitted to the router R2 while maintaining the wavelength λ1, through the optical add/drop multiplexers OADM1 and OADM2 of a ring network A, and further through the optical add/drop multiplexers OADM3 and OADM4 of a ring network B.

In FIG. 18, a branching port of the optical switch 8 corresponding to the same wavelength of an optical add/drop multiplexer OADM2 or the like is connected to an input port of an optical switch 21_1 within 8×8 type optical switches 21_1 to 21_128 forming an optical cross-connect (OXC) 20 so that a path may be directly established in an arbitrary (desired) ring network. Then, the output port is connected to the inserting port of the optical switch 8 such as optical add/drop multiplexer OADM3 or the like, thereby enabling routing to a desired ring network. Also in this example, as in FIG. 18, a signal with the same wavelength λ1 is transmitted in a path extending over ring networks.

A problem of a case without a wavelength conversion function will be described referring to FIG. 19.

For this case, it is hereby considered that when a path with the wavelength λ1 is established between the routers R2 and R4 in the ring network B, and a path is assumed to be established between the routers R1 and R3. Assuming that the router R1 is connected to the inserting port of the wavelength λ1 of a node N3, in the above case, a collision of the wavelengths λ1 against each other occurs in the ring network B, so that the path cannot be established.

Thus, there is no wavelength conversion function in a WDM ring network employing the optical add/drop multiplexer. Therefore, no path can be established across ring networks due to a collision in wavelength, although a path can be established with a collision-free wavelength within a ring network.

Accordingly, if the number of paths between the ring networks increases, utilization efficiency of wavelengths is lowered. Namely in the prior art WDM ring network connection arrangement, any wavelength conversion has not been performed between the ring networks. Alternatively, a large-scale optical switch function has been required to obtain a wavelength conversion function.

### SUMMARY OF THE INVENTION

It is accordingly an object of the present invention to provide a node having a wavelength conversion function and a wavelength division multiplexing ring network constituted by these nodes.

In order to achieve the above-mentioned object, a node according to the present invention comprises: in order to connect wavelength division multiplexing ring networks, a signal inserter for converting a wavelength of a signal branched from a node connected to another ring network into a collision-free wavelength to be inserted into a signal of the ring network of the node itself. (claim 1)

This will be described referring to FIG. 1.

A ring network A is composed of nodes N1 to N4 as in the example of FIG. 19, and a router R1 is connected to the node N3. In addition, a ring network B is composed of nodes N5 to N8, a router R2 is connected to the node N7, and a router R3 is connected to the node N8.

In such a WDM ring network, considering a case where a signal with a wavelength λ1 transmitted from the router R1 is transferred to the ring network B through the nodes N3 and N4, a signal inserter 4 provided at the node N6 in the ring network B converts a wavelength λ1 of the signal branched from the node N4 in the ring network A into another collision-free wavelength λ2 in the ring network B, and inserts the converted wavelength into a signal in the ring network B.

Thus, in case where communications by means of the wavelength λ1 take place between the routers R2 and R4 in the ring network B, the path connection between the nodes N6 and N8 is possible by means of the other collision-free wavelength λ2 against this signal, and the path establishment between the router R1 of the ring network A and the router R3 of the ring network B is possible.

In this way, a signal can be inserted by use of an arbitrary collision-free wavelength in a desired ring network by means of the signal inserter 4.

It is to be noted that the above-mentioned signal inserter 4 may be provided at the node N6, as mentioned above, and may also be provided in the node N4 or between the nodes N4 and N6. (claim 10)

The above-mentioned node may further comprise: a demultiplexer demultiplexing an input signal; an optical switch for passing/dropping a signal for each wavelength demultiplexed by the demultiplexer; and a multiplexer for multiplexing a signal passed through the optical switch. The signal inserter may convert a signal dropped from the optical switch in a node with a same configuration connected to the other ring network into a collision-free wavelength to be inserted into an output port of the multiplexer. (claim 2)

Additionally, the above-mentioned node may further comprise: a demultiplexer for demultiplexing an input signal; an optical switch for inserting/passing/dropping a signal for each wavelength demultiplexed by the demultiplexer; and a combining coupler for coupling signals passed/inserted by the optical switch. The signal inserter may convert a signal dropped from the optical switch in a node with a same configuration connected to the other ring network into a collision-free wavelength to be inserted into an inserting port of the optical switch in the node itself. (claim 3)

Additionally, the above-mentioned node may further comprise: a branching coupler for branching an input signal; a first demultiplexer for demultiplexing a wavelength multiplexed signal branched by the branching coupler; a second demultiplexer for demultiplexing other wavelength multiplexed signals branched by the branching coupler; an optical gate for passing/interrupting a signal for each wavelength demultiplexed by the second demultiplexer; and a multiplexer for multiplexing an output signal of the optical gate. The signal inserter may convert a signal demultiplexed by the first demultiplexer in a node with a same configuration connected to the other ring network into a collision-free wavelength to be inserted into an output port of the multiplexer. (claim 4)

Additionally, the above-mentioned node may further comprise: a branching coupler for branching an input signal; a first demultiplexer for demultiplexing wavelength multiplexed signals branched by the branching coupler; a second demultiplexer for demultiplexing other wavelength multiplexed signals branched by the branching coupler; an optical switch for inserting/passing a signal for wavelength demultiplexed by the second demultiplexer; and a combining coupler for coupling output signals of the optical switch. The signal inserter may convert a signal demultiplexed by the first demultiplexer in a node with a same configuration connected to the other ring network into a collision-free wavelength to be inserted into an inserting port of the optical switch. (claim 5)

Additionally, the above-mentioned node may further comprise: a branching coupler for branching an input signal; an optical extractor for extracting a signal of a desired wavelength from wavelength multiplexed signals branched by the branching coupler; a demultiplexer for demultiplexing other wavelength multiplexed signals branched by the branching coupler; an optical switch for inserting/passing a signal for each wavelength demultiplexed by the demultiplexer; and a combining coupler for coupling output signals of the optical switch. The signal inserter may convert a signal extracted by the optical extractor in a node with a same configuration connected to the other ring network into a collision-free wavelength to be inserted into an inserting port of the optical switch. (claim 6)

Additionally, the above-mentioned node may further comprise: a branching coupler for branching an input signal; an optical extractor for extracting a signal with a desired wavelength from wavelength multiplexed signals branched by the branching coupler; a demultiplexer for demultiplexing other wavelength multiplexed signals branched by the branching coupler; an optical gate for passing/interrupting a signal for each wavelength demultiplexed by the demultiplexer; and a multiplexer for multiplexing an output signal of the optical gate. The signal inserter may convert a signal extracted from the optical extractor in a node with a same configuration connected to the other ring network into a collision-free wavelength to be inserted into an output port of the demultiplexer. (claim 7)

Furthermore, the above-mentioned node may further comprise an optical switch connected to the node for routing from an input port for inputting a signal with the same wavelength branched from a node connected to the other ring network to an output port for outputting a signal corresponding to the same wavelength to a desired node. (claim 8)

Additionally, in the above-mentioned node, a fixed-wavelength transponder may be provided between the input port and the node connected to the other ring network. (claim 9)

A wavelength division multiplexing ring network can be achieved by interconnecting such nodes. (claim 11)

### BRIEF DESCRIPTION OF THE DRAWINGS

FIG. 1 is a diagram for illustrating a concept of a ring and a wavelength division multiplexing ring network according to the present invention;

FIG. 2 is a circuit diagram showing an embodiment (1) of an optical add/drop multiplexer (OADM) employed as a node according to the present invention;

FIG. 3 is a circuit diagram showing an embodiment (1) of a wavelength division multiplexing ring network according to the present invention;

FIGS. 4A and 4B are circuit diagrams showing an embodiment (2) of an optical add/drop multiplexer (OADM) employed as a node according to the present invention;

FIG. 5 is a circuit diagram showing an embodiment (2) of a wavelength division multiplexing ring network according to the present invention;

FIGS. 6A and 6B are circuit diagrams showing an embodiment (3) of an optical add/drop multiplexer (OADM) employed as a node according to the present invention;

FIG. 7 is a circuit diagram showing an embodiment (3) of a wavelength division multiplexing ring network according to the present invention;

FIGS. 8A and 8B are circuit diagrams showing an embodiment (4) of an optical add/drop multiplexer (OADM) employed as a node according to the present invention;

FIG. 9 is a circuit diagram showing an embodiment (4) of a wavelength division multiplexing ring network according to the present invention;

FIG. 10 is a circuit diagram showing an embodiment (5) of an optical add/drop multiplexer (OADM) employed as a node according to the present invention;

FIG. 11 is a circuit diagram showing an embodiment (5) of a wavelength division multiplexing ring network according to the present invention;

FIG. 12 is a circuit diagram showing an embodiment (6) of an optical add/drop multiplexer (OADM) employed as a node according to the present invention;

FIG. 13 is a circuit diagram showing an embodiment (6) of a wavelength division multiplexing ring network according to the present invention;

FIG. 14 is a circuit diagram showing an embodiment (7) of a wavelength division multiplexing ring network according to the present invention;

FIG. 15 is a circuit diagram showing an embodiment (8) of a wavelength division multiplexing ring network according to the present invention;

FIG. 16 is a circuit diagram showing an arrangement of a prior art optical add/drop multiplexer;

FIG. 17 is a circuit diagram showing a prior art example (1) of a wavelength division multiplexing ring network;

FIG. 18 is a circuit diagram showing a prior art example (2) of a wavelength division multiplexing ring network; and

FIG. 19 is a conceptual diagram for describing prior art problems.

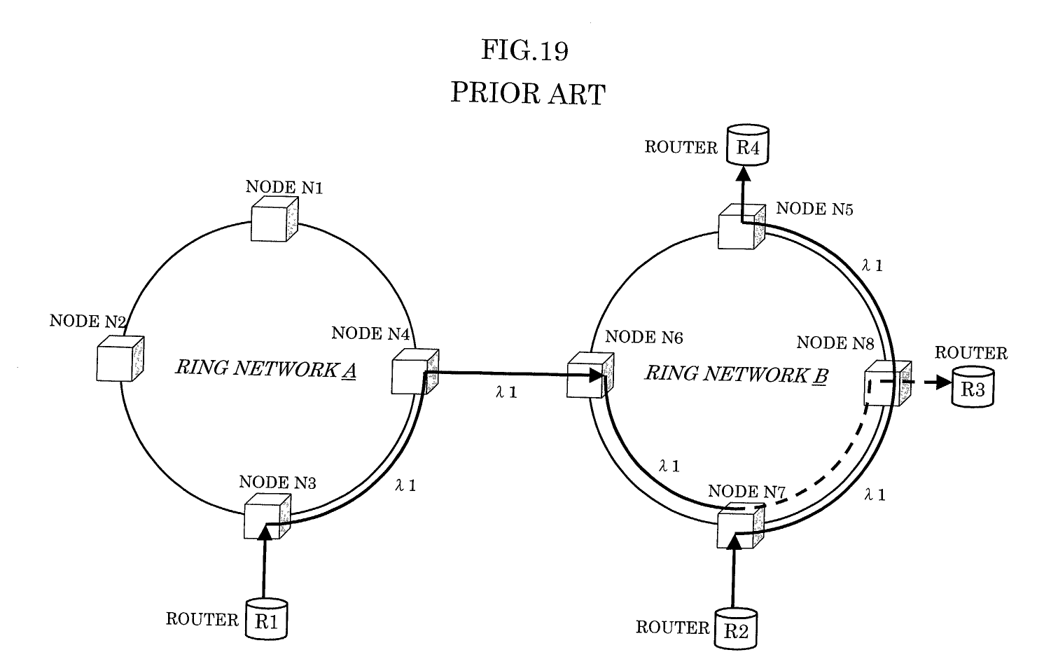

Throughout the figures, like reference numerals indicate like or corresponding components.

### DESCRIPTION OF THE EMBODIMENTS

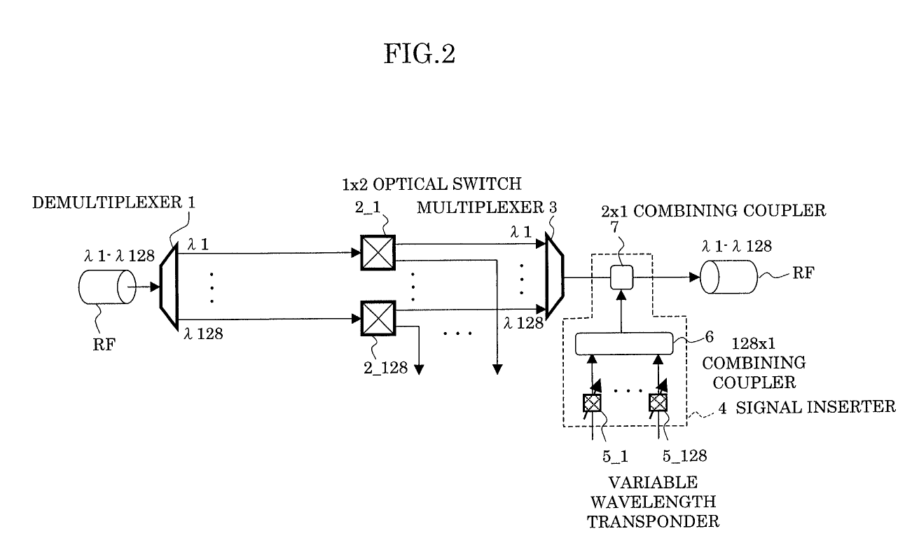

FIG. 2 shows an embodiment (1) of an optical add/drop multiplexer (hereinafter, occasionally abbreviated as OADM) employed as a node according to the present invention. This embodiment shows an example in which wavelength division multiplexed signals of wavelengths λ1 to λ128 are inputted from a ring type optical fiber RF.

Accordingly, a demultiplexer 1 for demultiplexing an input signal into the wavelengths λ1 to λ128 is connected to the optical fiber RF. To this demultiplexer 1, 1×2 type optical switches 2_1 to 2_128 for the wavelengths λ1 to λ128 are further connected, and a signal demultiplexed by the demultiplexer 1 for each wavelength is passed or branched.

To these optical switches 2_1 to 2_128, a multiplexer 3 for multiplexing signals passing through with the wavelengths λ1 to λ128 and outputting these signals to the ring type optical fiber RF is connected. Output signals other than the said signals of the optical switches 2_1 to 2_128 are branch signals (drop signals), and are inserted into its own node, or alternatively, into another ring network as will be described later.

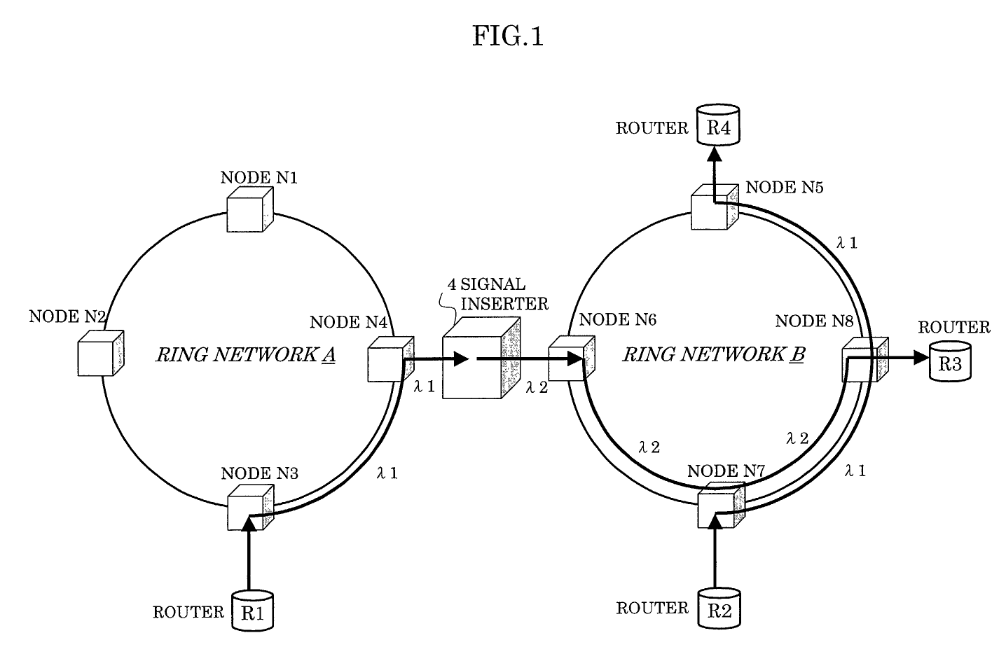

Additionally, the signal inserter 4 shown in FIG. 1 is inserted and connected between the multiplexer 3 and the ring type optical fiber RF. This signal inserter 4 is composed of variable-wavelength transponders 5_1 to 5_128 for converting wavelengths of signals branched from a node connected to a ring network other than that shown in FIG. 2 including the optical add/drop multiplexer into collision-free wavelengths, a 128×1 type combining coupler 6 for coupling output signals of these variable-wavelength transponders 5_1 to 5_128, and a 2×1 type combining coupler 7 for coupling the output signal of the combining coupler 6 with the output signal of the multiplexer 3.

Thus, in the embodiment (1) of the optical add/drop multiplexer (OADM), the signals with wavelengths λ1 to λ128 demultiplexed by the demultiplexer 1 are respectively switched over to a pass signal or a branch signal by means of optical switches 2_1 to 2_128. The branch signal is sent to another ring network or its own node, and the pass signals with wavelengths λ1 to λ128 are multiplexed by the multiplexer 3.

The above multiplexed signals are coupled with the wavelength converted signals from the signal inserter 4 by means of the combining coupler 7, and then, are transmitted to the ring type optical fiber RF.

It is to be noted that the variable-wavelength transponders 5_1 to 5_128 in the signal inserter 4 arrange 128 variable wavelength filters having a variable wavelength range of λ1 to λ128, and couple the signals by means of a combining coupler 6. However, the number of wavelengths of signals passed through the ring type optical fiber RF is properly selected, respectively, such that the wavelengths fall in the range of λ1 to λ128.

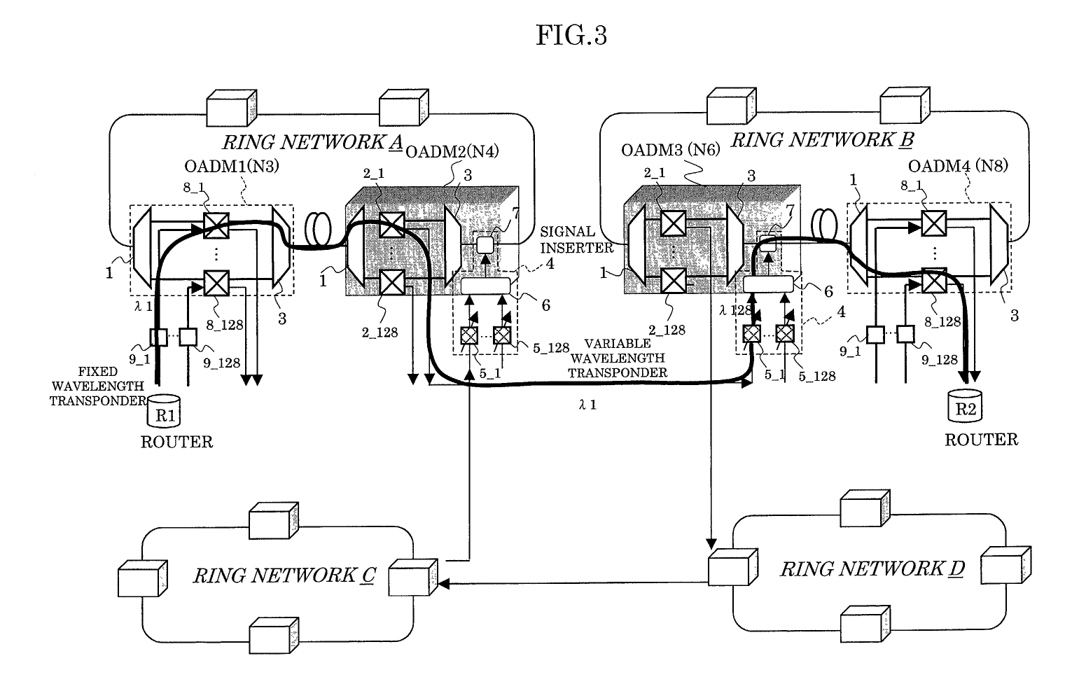

FIG. 3 shows an embodiment (1) in which the optical add/drop multiplexer (OADM) shown in FIG. 2 is applied to the WDM ring network.

That is, this WDM ring network corresponds to that shown in FIG. 1. The optical add/drop multiplexer OADM1 is employed as a node N3 in the ring network A, and the optical add/drop multiplexer OADM2 is employed as a node N4.

Similarly, also in the ring network B, the optical add/drop multiplexer OADM3 is employed as a node N6, and the optical add/drop multiplexer OADM4 is employed as a node N8.

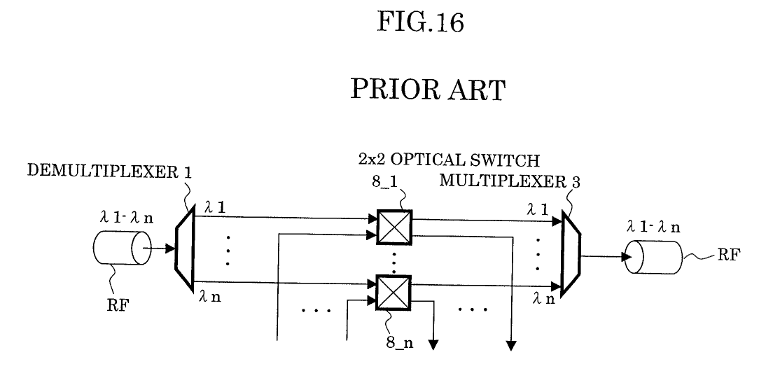

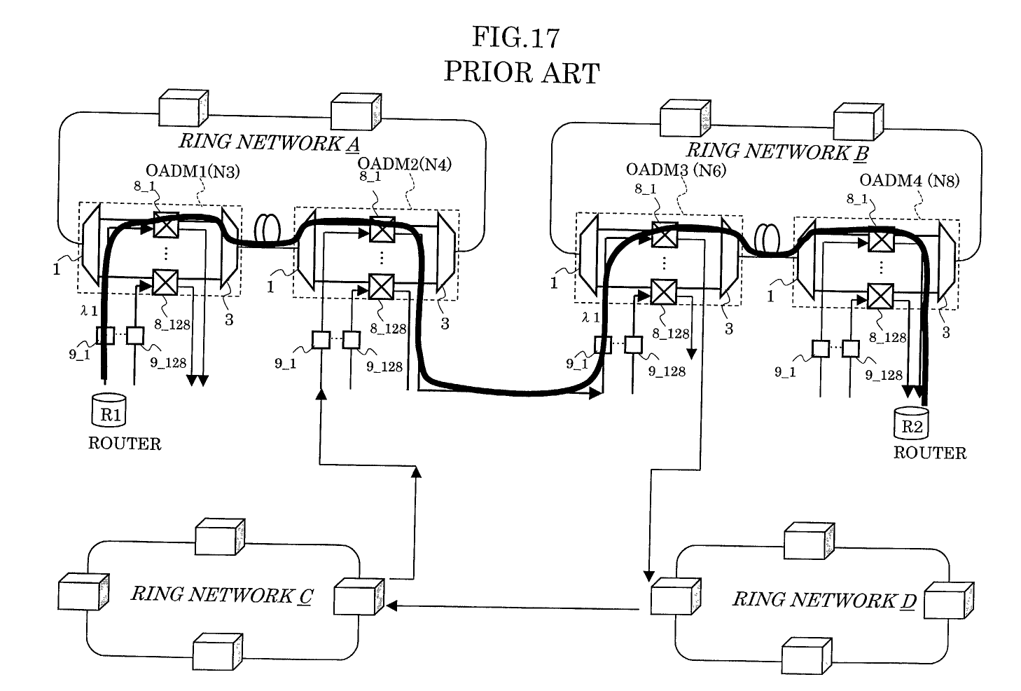

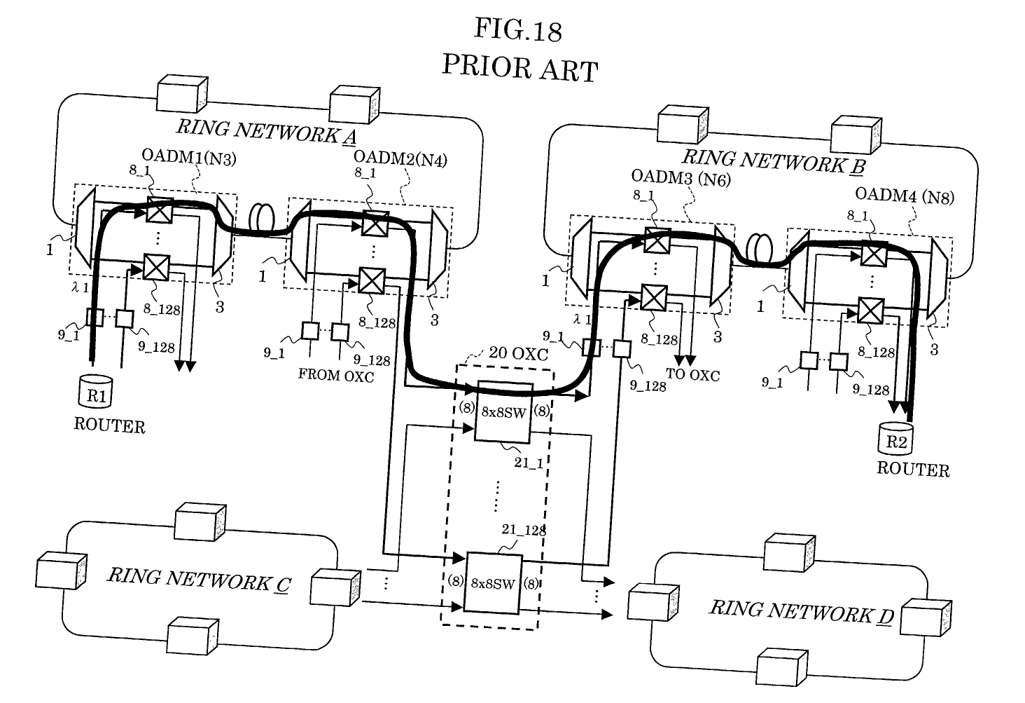

Among them, the optical add/drop multiplexers OADM1 and OADM4 are identical to the prior art optical add/drop multiplexers shown in FIGS. 16 to 18. As in the prior art example, fixed-wavelength transponders 9_1 to 9_128 are respectively connected to the inserting ports of the optical switches 8_1 to 8_128.

Then, the optical add/drop multiplexer OADM2 and OADM3 correspond to those shown in FIG. 2, and have a construction common to each other.

In this embodiment, the branch signal of the optical switch 2_1 in the optical add/drop multiplexer OADM2 is provided to the variable-wavelength transponder 5_1 of the signal inserter 4 in the optical add/drop multiplexer OADM3.

Therefore, as illustrated, the signal with a wavelength λ1 from the router R1 is sent to the fixed-wavelength transponder 9_1, the optical switch 8_1, the multiplexer 3, the demultiplexer 1 of the optical add/drop multiplexer OADM2, the optical switch 2_1, and the variable-wavelength transponder 5_1 of the signal inserter 4 in the optical add/drop multiplexer OADM3.

Then, the wavelength is converted into a collision-free wavelength λ128 in the ring network B by means of the variable-wavelength transponder 5_1 the converted wavelength is inserted into the output signal of the multiplexer 3 through the combining couplers 6 and 7. Then, the inserted output signal is transmitted to the router R2 through the demultiplexer 1 and the optical switch 2_128 of the optical add/drop multiplexer OADM4.

In this way, a signal branched from one ring network is sent to a node of another ring network, and is wavelength converted there. Then, the converted signal is inserted into the ring network, thereby enabling connection between various ring networks including the ring networks C and D as well as the ring networks A and B.

It is to be noted that although the optical add/drop multiplexers OADM2 and OADM3 employ the identical construction, any signal branched from another ring network can be inserted into a signal of the ring network of the own node by the wavelength conversion at the signal inserter 4.

Additionally, the signal inserter 4 may be provided anywhere in an inter-ring connection node or between nodes.

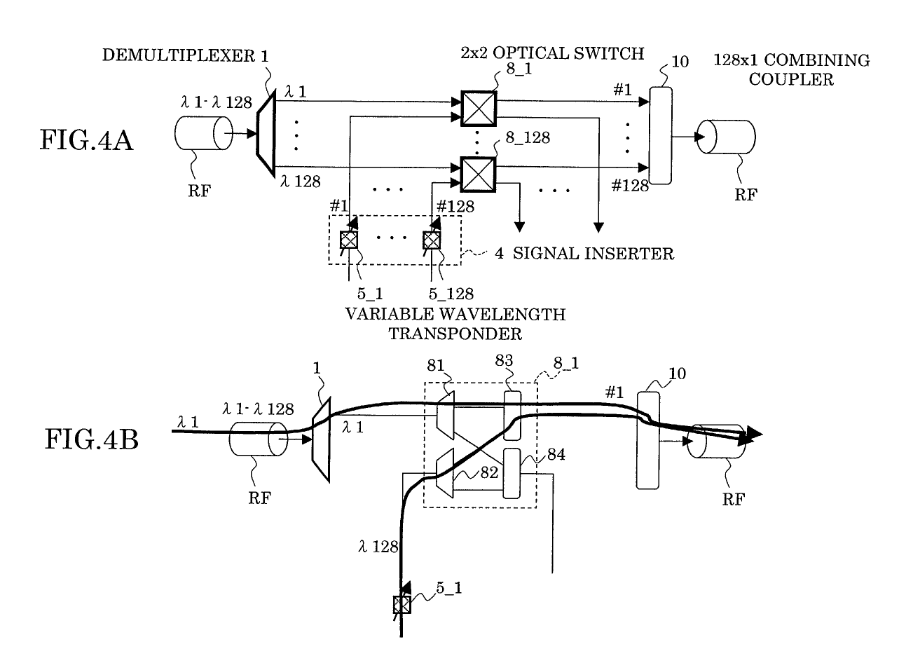

FIG. 4A shows an embodiment (2) of the optical add/drop multiplexer (OADM) employed as a node according to the present invention. In this embodiment, 2×2 type optical switches 8_1 to 8_128 are substituted for the optical switches 2_1 to 2_128 in the embodiment (1) shown in FIG. 2, and a 128×1 type combining coupler 10 is substituted for the multiplexer 3. Also, it is different from the embodiment (1) in that the signal inserter 4 is connected to the inserting port of the optical switches 8_1 to 8_128, not to the output side of the combining coupler 10.

That is, 2×2 type optical switches 8_1 to 8_128 are respectively connected to each of wavelengths λ1 to λ128 demultiplexed by the demultiplexer 1, and the insert signal, the branch signal, and the pass signal are switched over by means of the optical switches 8_1 to 8_128. Additionally, the pass signal is coupled by means of the combining coupler 10 to be transmitted to the ring type optical fiber RF.

Only the variable-wavelength transponders 5_1 to 5_128 for the number of wavelengths are provided at the signal inserter 4, so that any signals with collision-free wavelengths can be inserted into a ring network.

It is to be noted that the combining coupler 10 is substituted for a multiplexer because there is a possibility that an arbitrary wavelength is inputted to an input port #1 of e.g. the combining coupler 10.

Additionally, considering cases where the wavelength λ1 is set as a pass signal and a signal with wavelength λ128, for example, is inserted at the optical switch 8_1 from the variable-wavelength transponder 5_1, signals of both wavelengths λ1 and λ128 cannot be outputted to the transmission line in a usual 2×2 type optical switch at this time.

Therefore, a 2×2 type optical switch in which 1×2 type optical switches 81 and 82, and 2×1 type combining couplers 83 and 84 are combined with each other, as shown in FIG. 4B, is constructed, thereby enabling both signals to be outputted as illustrated.

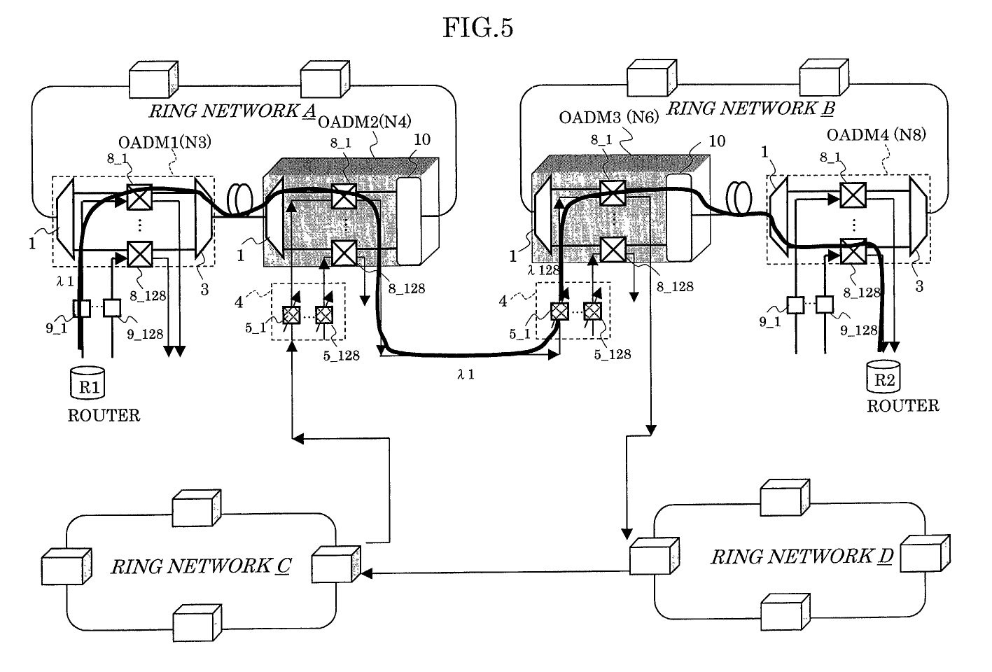

In FIG. 5, the optical add/drop multiplexer (OADM) shown in FIG. 4 is applied, respectively, as optical add/drop multiplexers OADM2 and OADM3 for the nodes N4 and N6 as in the embodiment (1) of FIG. 3.

Therefore, in case of this embodiment, a signal with a wavelength λ1 obtained by the fixed-wavelength transponder 9_1 from the router R1 is transmitted from the optical add/drop multiplexer OADM1 to the OADM2. The signal becomes a branch signal at the optical switch 1_8. In the variable-wavelength transponder 5_1 in the signal inserter 4 of the optical add/drop multiplexer OADM3, the branch signal is converted into a signal with collision-free wavelength λ128 in the ring network B, so that the converted signal is transmitted to the optical add/drop multiplexer OADM4 through the optical switch 8_1 and the combining coupler 10, and is further transmitted to the router R2.

It is to be noted that also in this embodiment, as in the above case, a signal branched from various other ring networks can be inserted into the ring network of the node itself through the signal inserter 4, and the connection between the ring networks as illustrated can be arranged.

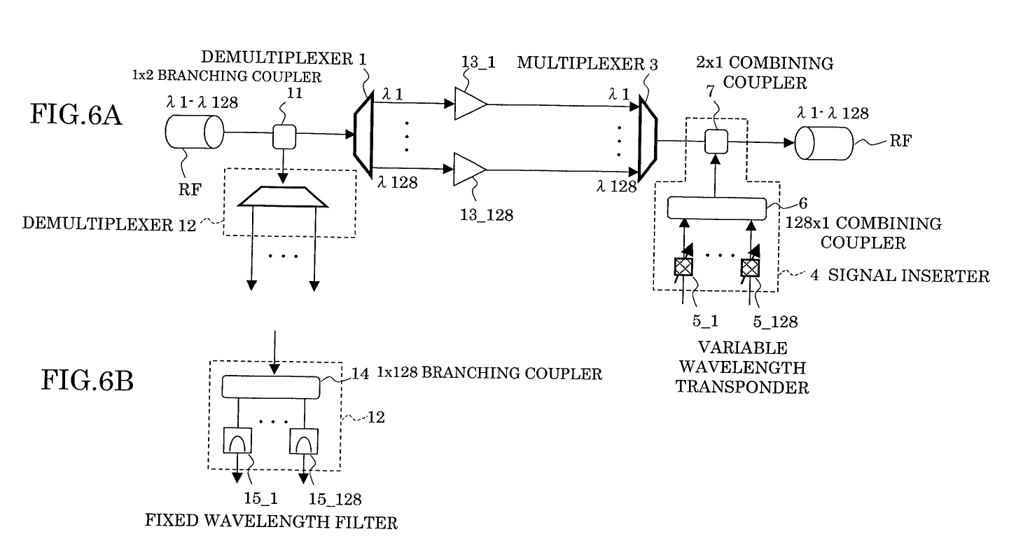

FIGS. 6A and 6B show an embodiment (3) of an optical add/drop multiplexer (OADM) employed as a node according to the present invention. This embodiment shown in FIG. 6A is different from other embodiments in that, at the input side of the demultiplexer 1 in the embodiment (2) of the optical add/drop multiplexer (OADM) of FIG. 2, a 1×2 type branching coupler 11 and a demultiplexer 12 for demultiplexing a signal branched by the branching coupler 11 for each wavelength are provided, and gates 13_1 to 13_128 for respectively passing or interrupting signals with wavelengths λ1 to λ128 outputted from the demultiplexer 1 are substituted for the optical switches 2_1 to 2_128.

That is, before reaching the demultiplexer 1, the WDM signal branched by the 1×2 type branching coupler 11 is demultiplexed by means of the demultiplexer 12 for each wavelength, resulting in a branch signal for another ring network or its own node.

On the other hand, signals flowing within a ring network are switched over to be passed or not to be passed by controlling gates 13_1 to 13_128 provided for each wavelength demultiplexed by the demultiplexer 1.

When the signals are passed, the signals are, after having been multiplexed by the multiplexer 3, coupled, in the same way as the embodiment (1) in FIG. 2, with an insert signal at the combining coupler 7 by means of the signal inserter 4. The signal inserter 4 in this case also arranges 128 variable wavelength filters having a variable range of λ1 to λ128 to be wavelength-division-multiplexed by means of the combining coupler 6.

FIG. 6B shows a modification of the demultiplexer 12 in the FIG. 6A. In this modification, this demultiplexer 12 is composed of a 1×28 type branching coupler 14, and fixed wavelength filters 15_1 to 15_128 for inputting 128 output signals outputted from the branching coupler 14 and extracting only a predetermined wavelength.

Thus, as in the above description, it becomes possible to demultiplex a WDM signal branched by the branching coupler 11 for each wavelength, thereby providing a branch signal.

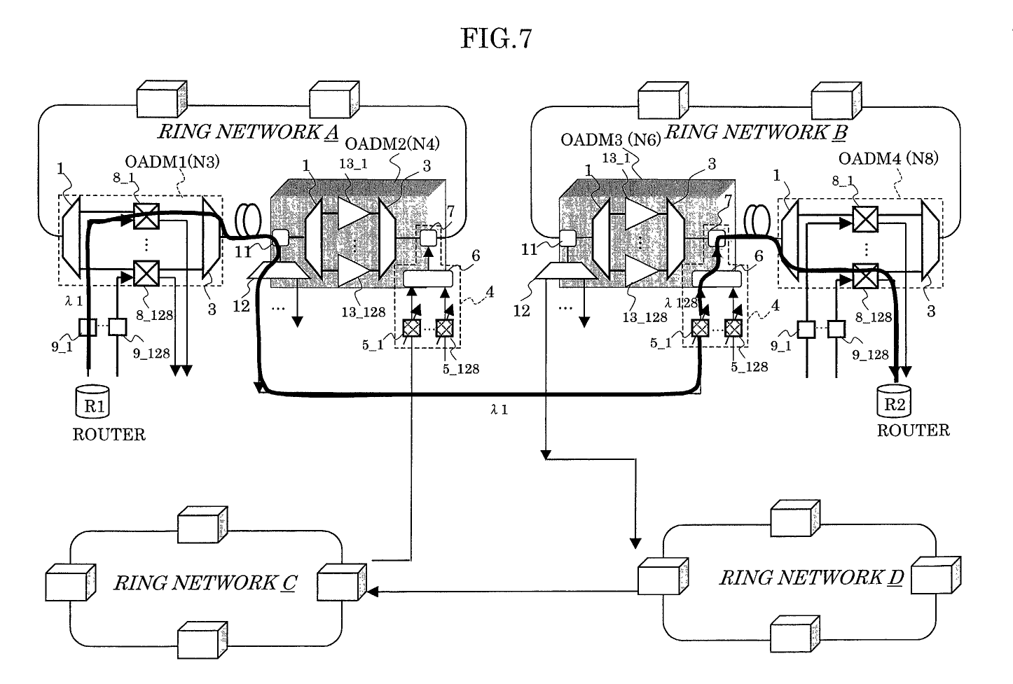

FIG. 7 shows an embodiment (3) of the WDM ring network using the embodiment (3) of the optical add/drop multiplexer shown in FIGS. 6A and 6B. In this embodiment as well, the optical add/drop multiplexer OADM2 is employed for the node N4 for interconnecting the ring networks A and B, and the optical add/drop multiplexer OADM3 is employed as a node N16.

Therefore, a signal with wavelength λ1, for example, from the router R1 is transmitted from the optical add/drop multiplexer OADM1 to the OADM2 in the ring network A. The signals branched by the branching coupler 11 are demultiplexed by the demultiplexer 12 for each wavelength. Among the demultiplexed signals, the signal with wavelength λ1 is transmitted to the variable-wavelength transponder 5_1 of the signal transponder 4 provided at the optical add/drop multiplexer OADM3 in the ring network B.

Then, at this variable-wavelength transponder 5_1, the signal is converted into the signal with collision-free wavelength λ128 in the ring network B. Then, the converted signal is inserted into a signal (output signal of the multiplexer 3) passing through the ring network B through combining couplers 6 and 7. Then, the inserted signal is transmitted to the router R2 through the demultiplexer 1 and the optical switch 8_128 in the optical add/drop multiplexer OADM4.

Thus, also in this embodiment, as in the above embodiments, it becomes possible to connect various WDM ring networks including ring networks C and D as well as the ring networks A and B.

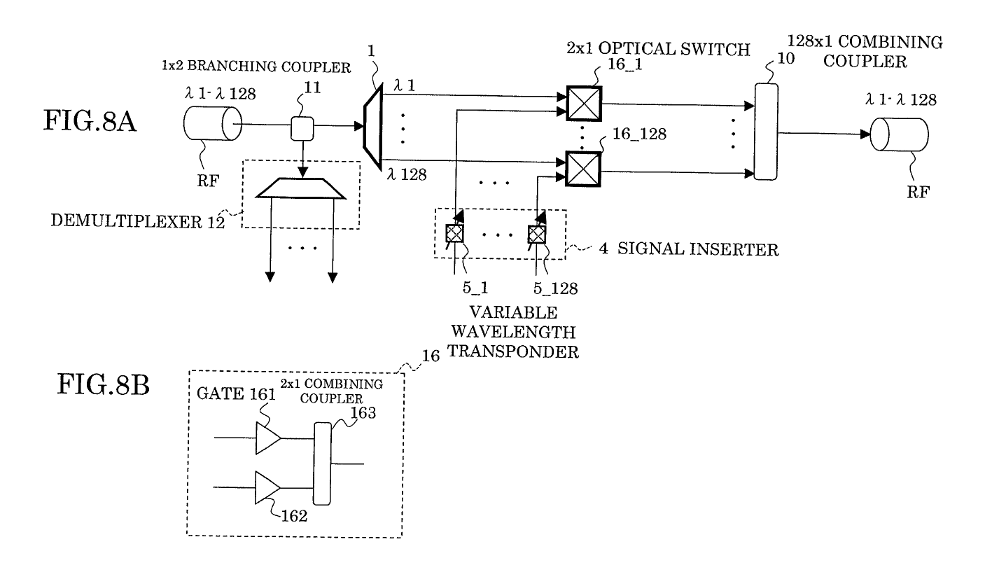

FIG. 8A shows an embodiment (4) of the optical add/drop multiplexer (OADM) employed as a node according to the present invention. This embodiment is different from the embodiment (3) shown in FIGS. 6A and 6B, in that 2×1 type optical switches 16_1 to 16_128 are substituted for the gates 13_1 to 13_128 in the embodiment (3) and the signal inserter 4 similar to that of the embodiment (2) in FIGS. 4A and 4B is connected to the inserting ports of the optical switches 16_1 to 16_128.

That is, before reaching the demultiplexer 1, the WDM signals branched by the 1×2 type branching coupler 11 as the above embodiment (3) are demultiplexed by the demultiplexer 12 for each wavelength, resulting in a branch signal.

On the other hand, signals passing through this ring network and insert signals from the signal inserter 4 are properly switched over by means of the 2×1 type optical switches 16_1 to 16_128 respectively provided for the wavelengths λ1 to λ128 demultiplexed by the demultiplexer 1.

The variable-wavelength transponders 5_1 to 5_128 for the number of wavelengths (128) are provided at the signal inserter 4 so that a signal can be inserted into a collision-free ring network.

Signals passing though the optical switches 16_1 to 16_128 or inserted signals are coupled, as described above, at the combining coupler 10 and are inserted into a ring type optical fiber RF.

In the optical switches 16_1 to 16_128 in FIG. 8A, if it is configured such that e.g. a signal with wavelength λ1 can be passed, both of the signals with wavelengths λ1 and λ128 cannot be transmitted to the transmission line in a usual 2×1 type optical switch, considering a case where the signal with wavelength λ128 converted by the variable-wavelength transponder 5_1 is to be inserted into the optical switch 16_1.

Thus, as shown in FIG. 8B, a combination, of gates 161 and 162 and a 2×1 type combining coupler 163 connecting input ports to the gates 161 and 162, enables both signals to be outputted.

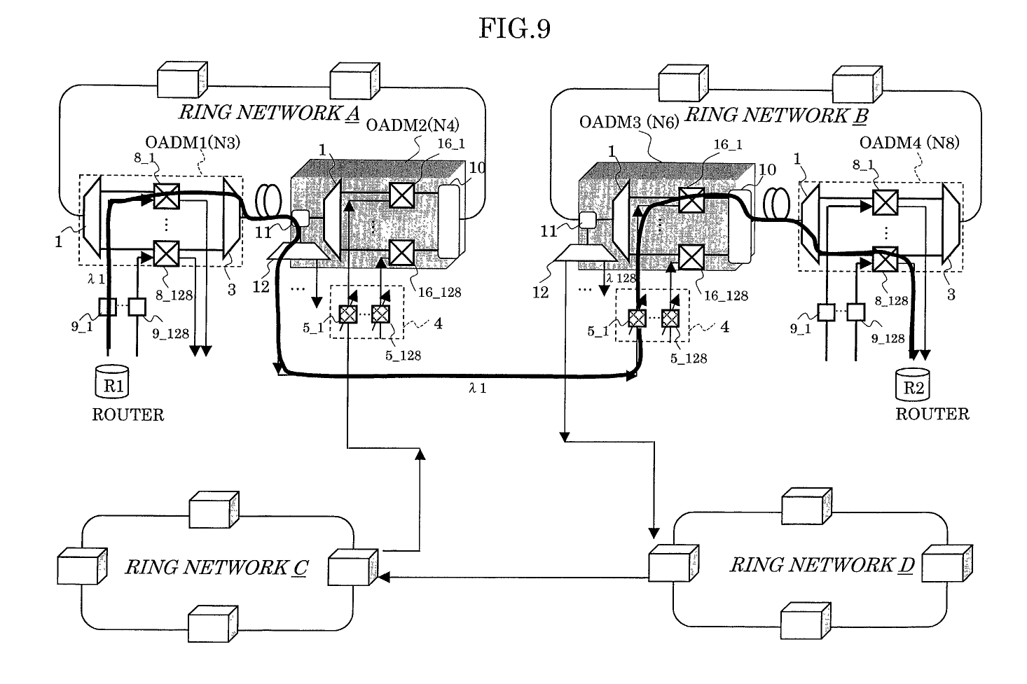

FIG. 9 shows an embodiment (4) of a WDM ring network in which the embodiment (4) of the optical add/drop multiplexer shown in FIGS. 8A and 8B is incorporated. This embodiment is different from the embodiment (2) shown in FIG. 5 as follows: while a branch signals are produced by means of the optical switches 8_1 to 8_128 in the embodiment (2), a WDM signal branched by the branching coupler 11 at a preceding stage of the demultiplexer 1 is demultiplexed for each wavelength by means of the demultiplexer 12, whereby the demultiplexed signal assumes a branch signal.

Therefore, when the signal with wavelength λ1 from the router R1 is transmitted from the optical add/drop multiplexer OADM1 to the optical add/drop multiplexer OADM2, the branching coupler 11 therein branches the input signal, and transmits the signal to the demultiplexer 12. The demultiplexed signal of the wavelength λ1 is, as a branch signal, transmitted to the variable-wavelength transponder 5_1 of the signal transponder 4 in the optical add/drop multiplexer OADM3 in the ring network B.

Then, this variable-wavelength transponder 5_1 converts a signal into a signal with collision-free wavelength λ128 in the ring network B. Thereafter, the converted signal is transmitted to the router R2 through the optical switch 16_1 and combining coupler 10 and through the demultiplexer 1 and the optical switch 8_128 of the optical add/drop multiplexer OADM4.

Thus, also in this embodiment, as shown in FIG. 9, mutual ring connection between the ring networks A to D can be achieved.

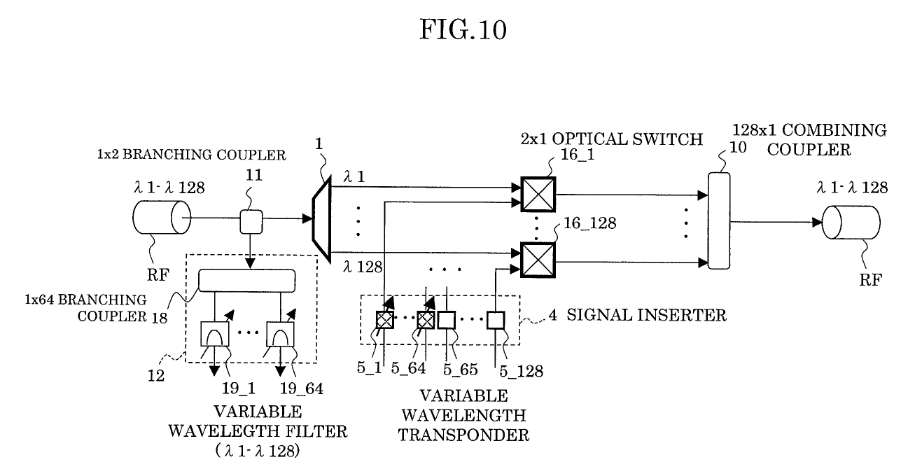

FIG. 10 shows an embodiment (5) of the optical add/drop multiplexer (OADM) used as a node according to the present invention. This embodiment is different from the embodiment (4) shown in FIGS. 8A and 8B in that a 1×64 type branching coupler 18 and 64 variable wavelength filters 19_1 to 19_64 in the embodiment (4) are employed as a demultiplexer 12, and correspondingly only the variable-wavelength transponders 5_1 to 5_64 out of the variable-wavelength transponders 5_1 to 5_128 in the signal inserter 4 are used.

That is, in this embodiment (5), the number of signals inserted/branched in the arrangement of the above embodiment (4) is made smaller than that of wavelengths within a ring (128 in this example), and the number of optical switches interconnecting the ring networks is reduced.

Therefore, a 1×64 type branching coupler 18 for branching an arbitrary wavelength from a WDM signal branched by the 1×2 type branching coupler 11 before reaching the demultiplexer 1 and variable wavelength filters 19_1 to 19_64 which cover the bandwidth of wavelengths λ1 to λ128 are provided. At the 128 ports in the signal inserter 4, only 64 insert signals required are inserted by providing the variable-wavelength transponders 5_1 to 5_64.

It is to be noted that in FIG. 10, although 128 variable-wavelength transponders 5_1 to 5_128 and 128 optical switches 16_1 to 16_128 are shown, it means that 64 of these components respectively are used.

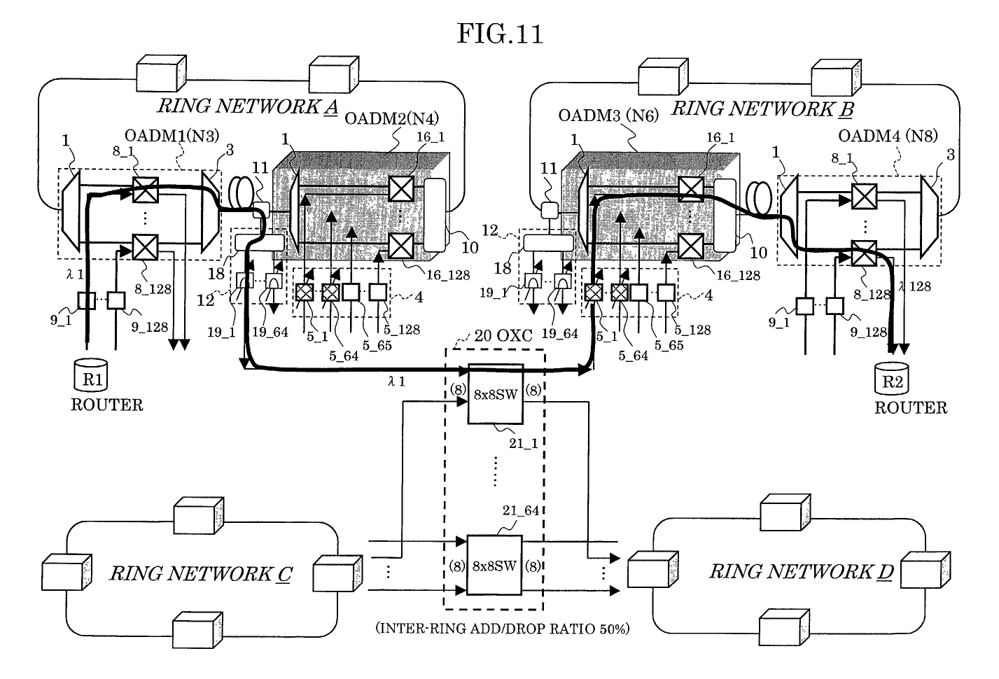

FIG. 11 shows an embodiment (5) in which the embodiment (5) of the optical add/drop multiplexer shown in FIG. 10 is incorporated into the WDM ring network. This embodiment further accommodates an optical cross-connect 20 comprising 8×8 type optical switches 21_1 to 21_64 in which branching ports of the same wavelength in the inter-ring connection nodes in order to mutually connect 8 ring networks, and routing is performed to the inserting ports corresponding to the same wavelength of the desired inter-ring connection nodes.

That is, in this embodiment, an inter-ring network add/drop ratio is assumed 50%. A branch signal is obtained, for example, from the optical add/drop multiplexer OADM2 in the ring network A by employing 64 variable wavelength filters 19_1 to 19_64, as shown in the embodiment (5) of FIG. 10.

This branch signal is provided to the input port of the 8×8 type optical switch 21_1 in an optical cross-connect (OXC) 20. Then, a signal with wavelength λ1 from the output port of this optical switch 21_1 is converted into a signal with collision-free wavelength λ128 in the ring network B by means of variable wave length transponder 5_1 within a signal inserter 4 in the ring network B to be inserted into the ring network B.

Therefore, as shown in this embodiment, in case where an inter-ring add/drop ratio is assumed 50%, the number of optical switches in the optical cross-connect 20 is 64 as illustrated.

In this way, the signal of the wavelength λ1 from the router R1 is finally transmitted to the router R2 through the Optical add/drop multiplexers OADM1 and OADM2, and further, through the optical add/drop multiplexers OADM3 and OADM4 in the ring network B through the optical cross-connect 20.

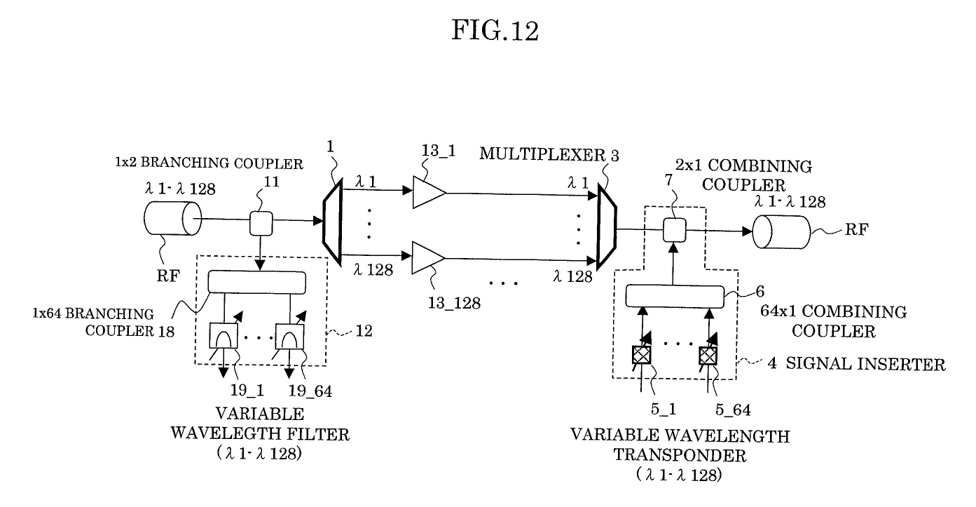

FIG. 12 shows an embodiment (6) of the optical add/drop multiplexer (OADM) employed as a node according to the present invention. This embodiment is different from the embodiment (3) shown in FIGS. 6A and 6B in that, although the variable wavelength filter employed in the demultiplexer 12 covers the bandwidth of wavelengths λ1 to λ128, 64 variable wavelength filters 19_1 to 19_64 are employed since its drop ratio is 50%, and in that, although the variable-wavelength transponder in the signal inserter 4 also covers the wavelengths λ1 to λ128 corresponding to the same, only 64 variable-wavelength transponders 5_1 to 5_64 are provided since its add ratio is 50%.

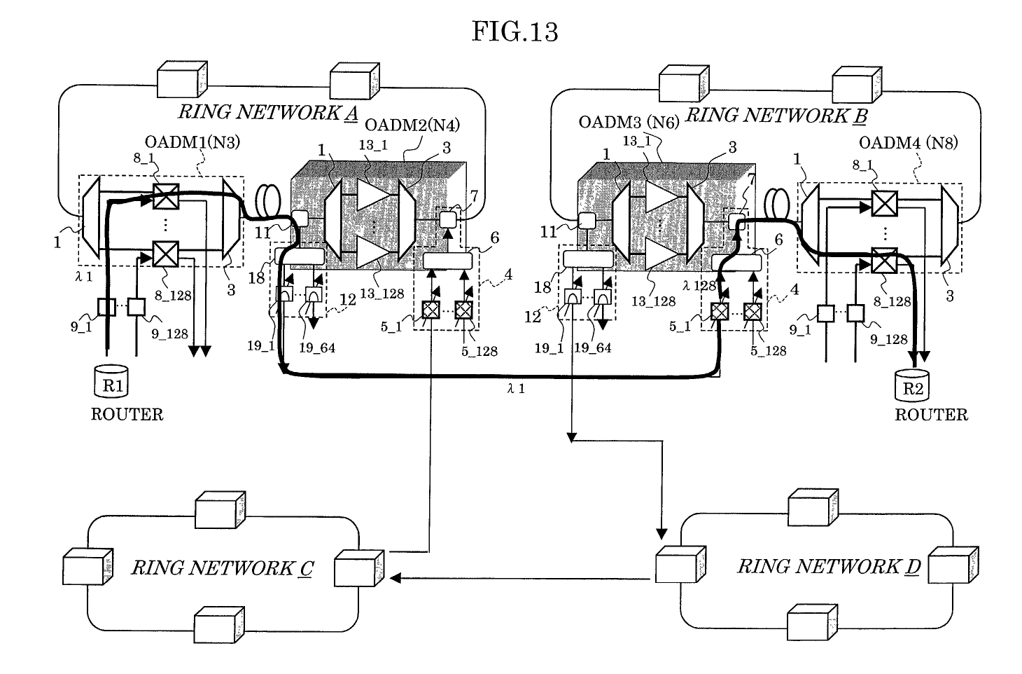

FIG. 13 shows an embodiment (6) of a WDM ring network employing the embodiment (6) of FIG. 12. In this embodiment, particularly, the optical cross-connect 20 as shown in FIG. 11 is not employed.

Therefore, when the signal of the wavelength λ1 from the router R1 in the ring network A is inputted to the optical add/drop multiplexer OADM2 through the optical add/drop multiplexer OADM1, the WDM signal branched by the branching coupler 11 is branched into signals with 64 wavelengths by the branching coupler 18.

Predetermined wavelengths of these branch signals are extracted in the range of wavelengths λ1 to λ128 by means of the variable wavelength filters 19_1 to 19_64. For example, the signal of the wavelength λ1 is transmitted to the variable-wavelength transponder 5_1 at the signal inserter 4 in the ring network B.

In this variable-wavelength transponder 5_1, the signal is converted into a collision-free wavelength λ128 in the ring network B. Thereafter, the converted signal is inserted into a pass signal passing through the ring network B through the combining couplers 6 and 7. Then, the inserted signal is transmitted to the router R2 via the demultiplexer 1 and the optical switch 8_128 in the optical add/drop multiplexer OADM4.

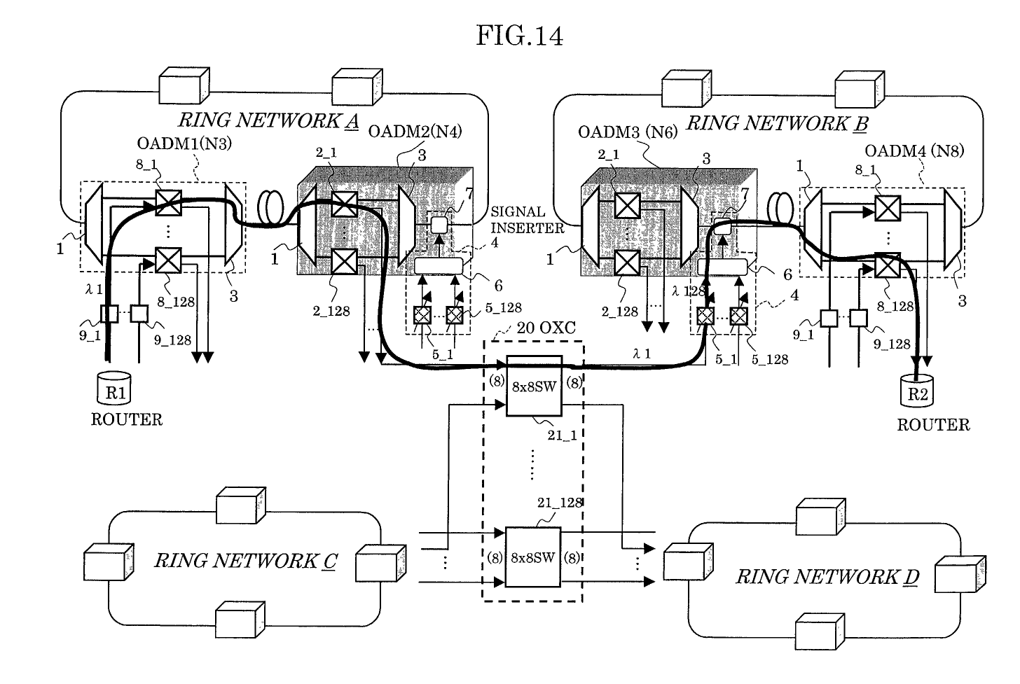

FIG. 14 is different from the embodiment (1) of the WDM ring network shown in FIG. 3 only in that the optical cross-connect 20 as shown in the embodiment (5) of FIG. 11 is inserted between the optical add/drop multiplexers OADM2 and OADM3.

Therefore, as illustrated, it is possible that the signal of the wavelength λ1 branched from the optical add/drop multiplexer OADM2 is transmitted not only to the signal inserter 4 of the ring network B as illustrated by means of the 8×8 type optical switch 21_1 but also to e.g. the optical add/drop multiplexer of the ring network D.

In this way, signals branched by means of the optical switches in the connection node between rings are switched over in all combinations, thereby enabling the WDM ring network to be mutually arranged.

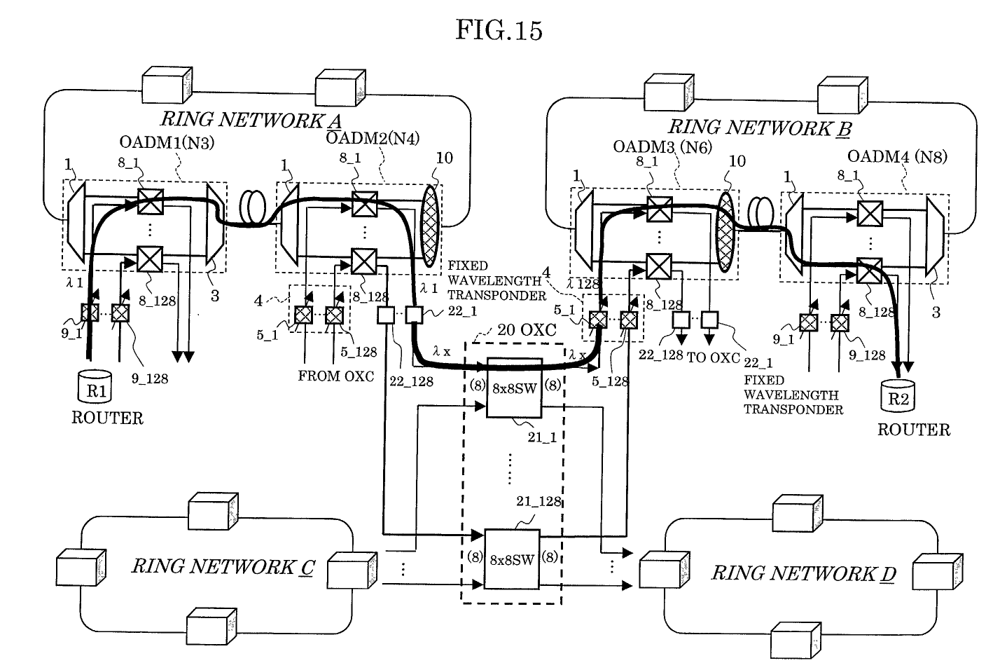

In FIG. 15, in the embodiment (2) of the WDM ring network of FIG. 5, in the same way as the above-mentioned description, the optical cross-connect 20 is further provided between the optical add/drop multiplexers OADM2 and OADM3. In this case, fixed-wavelength transponders 22_1 to 22_128 are further provided at the branching port side of the optical switches 8_1 to 8_128 of the optical add/drop multiplexer OADM2.

In this manner, all combinations between ring network can be achieved by means of the optical cross-connect 20. In addition, for example, even in case where the ring network and the optical cross-connect node 20 are spatially apart, waveforms are shaped by means of the fixed-wavelength transponders 22_1 to 22_128, thereby enabling connection between rings. In addition, the interface at the optical cross-connect of the fixed-wavelength transponders 22_1 to 22_128 is assumed to be e.g. an inexpensive interface of 1.3 μm in bandwidth, so that the interface of 1.3 μm in bandwidth may be applied to the optical switches.

As described above, a node and wavelength division multiplexing ring network according to the present invention is arranged such that a wavelength of a signal branched from a node connected to another ring network is converted into a collision-free signal to be inserted into a signal of the network itself. Therefore, a wavelength conversion between ring networks becomes possible without employing any large-scale optical switch.

Consequently, wavelength collision between ring networks can be reduced and wavelength resource of a ring network can be saved. That is, costs of the optical add/drop multiplexer or junction node constructing a ring network generally can be reduced.

What we claim is:

1. A node for connecting wavelength division multiplexing ring networks comprising:
a signal inserter for converting a wavelength of a signal branched from a node connected to another ring network into a collision-free wavelength to be inserted into a signal of the ring network of the node itself.

2. The node as claimed in claim 1, further comprising:
a demultiplexer for demultiplexing an input signal;
an optical switch for passing/dropping a signal for each wavelength demultiplexed by the demultiplexer; and
a multiplexer for multiplexing a signal passed through the optical switch,
the signal inserter converting a signal dropped from the optical switch in a node with a same configuration connected to the other ring network into a collision-free wavelength to be inserted into an output port of the multiplexer.

3. The node as claimed in claim 1, further comprising:
a demultiplexer for demultiplexing an input signal;
an optical switch for inserting/passing/dropping a signal for each wavelength demultiplexed by the demultiplexer; and
a combining coupler for coupling signals passed/inserted by the optical switch,
the signal inserter converting a signal dropped from the optical switch in a node with a same configuration connected to the other ring network into a collision-free wavelength to be inserted into an inserting port of the optical switch in the node itself.

4. The node as claimed in claim 1, further comprising:
a branching coupler for branching an input signal;
a first demultiplexer for demultiplexing a wavelength multiplexed signal branched by the branching coupler;
a second demultiplexer for demultiplexing other wavelength multiplexed signals branched by the branching coupler;
an optical gate for passing/interrupting a signal for each wavelength demultiplexed by the second demultiplexer; and
a multiplexer for multiplexing an output signal of the optical gate,
the signal inserter converting a signal demultiplexed by the first demultiplexer in a node with a same configuration connected to the other ring network into a collision-free wavelength to be inserted into an output port of the multiplexer.

5. The node as claimed in claim 1, further comprising:
a branching coupler for branching an input signal;
a first demultiplexer for demultiplexing wavelength multiplexed signals branched by the branching coupler;
a second demultiplexer for demultiplexing other wavelength multiplexed signals branched by the branching coupler;
an optical switch for inserting/passing a signal for wavelength demultiplexed by the second demultiplexer; and
a combining coupler for coupling output signals of the optical switch,
the signal inserter converting a signal demultiplexed by the first demultiplexer in a node with a same configuration connected to the other ring network into a collision-free wavelength to be inserted into an inserting port of the optical switch.

6. The node as claimed in claim 1, further comprising:
a branching coupler for branching an input signal;
an optical extractor for extracting a signal of a desired wavelength from wavelength multiplexed signals branched by the branching coupler;
a demultiplexer for demultiplexing other wavelength multiplexed signals branched by the branching coupler;
an optical switch for inserting/passing a signal for each wavelength demultiplexed by the demultiplexer; and
a combining coupler for coupling output signals of the optical switch,
the signal inserter converting a signal extracted by the optical extractor in a node with a same configuration connected to the other ring network into a collision-free wavelength to be inserted into an inserting port of the optical switch.

7. The node as claimed in claim 1, further comprising:
a branching coupler for branching an input signal;
an optical extractor for extracting a signal with a desired wavelength from wavelength multiplexed signals branched by the branching coupler;
a demultiplexer for demultiplexing other wavelength multiplexed signals branched by the branching coupler;
an optical gate for passing/interrupting a signal for each wavelength demultiplexed by the demultiplexer; and
a multiplexer for multiplexing an output signal of the optical gate,
the signal inserter converting a signal extracted from the optical extractor in a node with a same configuration connected to the other ring network into a collision-free wavelength to be inserted into an output port of the demultiplexer.

8. The node as claimed in any one of claims 1 to 7, further comprising an optical switch connected to the node for routing from an input port for inputting a signal with the same wavelength branched from a node connected to the other ring network to an output port for outputting a signal corresponding to the same wavelength to a desired node.

9. The node as claimed in claim 8 wherein a fixed-wavelength transponder is provided between the input port and the node connected to the other ring network.

10. The node as claimed in claim 1 wherein the signal inserter is provided between other nodes or in another node.

11. A wavelength division multiplexing ring net comprising:
a plurality of interconnected nodes as claimed in any one of claims 1 to 10.
